(19) United States
(12) Patent Application Publication
(10) Pub. No.: US 2014/0359594 A1
(43) Pub. Date: Dec. 4, 2014

(54) REPOSITORY LAYER STRATEGY ADAPTATION FOR SOFTWARE SOLUTION HOSTING

(71) Applicants: Lars Erbe, Stutensee (DE); Stefan Haffner, Hockenheim (DE); Juergen Specht, Gerabronn (DE); Da Pan, Shanghai (CN); Martin Kaiser, Mannheim (DE)

(72) Inventors: Lars Erbe, Stutensee (DE); Stefan Haffner, Hockenheim (DE); Juergen Specht, Gerabronn (DE); Da Pan, Shanghai (CN); Martin Kaiser, Mannheim (DE)

(73) Assignee: SAP AG, Walldorf (DE)

(21) Appl. No.: 13/913,249

(22) Filed: Jun. 7, 2013

(30) Foreign Application Priority Data
Jun. 4, 2013 (CN) 201310218476.8

(51) Int. Cl. G06F 9/445

(52) U.S. Cl. CPC G06F 8/65
USPC 717/169

(57) ABSTRACT

Upon an installation of a new software release at a multitenant computing system, a list of layers of a pre-existing layer strategy in use at the multitenant computing system can be read. As part of the installation of the new release, an updated bottom layer in a repository of the multitenant computing system can also be installed. A target set of software components for a tenant of the multitenant computing system can be determined, for example by reading a metadata definition of the target set for a layer of a repository of the multitenant computing system to which the tenant is assigned. The tenant can be configured consistent with the target set of software components.

### RELATED APPLICATION

This application claims priority of Chinese Patent Application No. 201310218476.8 filed on Jun. 4, 2013, the disclosure of which is incorporated herein by reference in its entirety.

### TECHNICAL FIELD

The subject matter described herein relates generally to layering strategies in data repositories, and in some more specific implementations, to layering strategies in data repositories for multi-tenant systems.

### BACKGROUND

Many businesses and other organizations make use of business software frameworks (also referred to as software architectures) to support integrated, computer-based management of internal and external resources, such as for example tangible assets, financial resources, materials, customer relationships, and human resources. Examples of business software frameworks include enterprise resource planning (ERP) systems, which can be designed to facilitate the flow of information between business functions inside the boundaries of the organization and manage the connections to outside service providers, stakeholders, and the like.

Business software frameworks including ERP systems can typically include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate on a local area network or over a network, such as for example the Internet, a wide area network, a local area network, or the like.

As part of the installation process of the core software platform on computing hardware owned or operated by the organization, one or more customized features, configurations, business processes, or the like can be added to the default, preprogrammed features such that the core software platform is configured for maximum compatibility with the organization's business processes, data, and the like.

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. Smaller organizations can also benefit from use of ERP functionality. However, such an organization can lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it is typically advantageous to host multiple tenants on a single system that includes multiple servers and that maintains data for all of the multiple tenants in a secure manner while also providing customized solutions that are tailored to each tenant's business processes.

### SUMMARY

Implementations of the current subject matter can support functionality that reduces a required amount of administration effort for metadata repository layer strategy maintenance. Such an approach can optionally provide one or more advantages over previously available solutions. These advantages can include, but are in no way limited to reducing one or more of an amount of manual effort required during tenant setups or system upgrades, a time required to setup new tenants or upgrade existing tenants, a frequency of occurrence of errors during tenant setups and system upgrades, costs to setup new tenants and upgrade existing tenants, capital costs for additional systems to host different software solutions, development cost (e.g. due to reuse of development systems for different solutions), and the like.

In one aspect, a method includes reading, upon an installation of a new software release at a multitenant computing system, a list of layers of a pre-existing layer strategy in use at the multitenant computing system. As part of the installation of the new release an updated bottom layer is installed in a repository of the multitenant computing system. The updated bottom layer includes software components available for use in one or more tenants of the multitenant computing system. A target set of software components is determined for a tenant of the multitenant computing system. The determining includes reading a metadata definition of the target set for a layer of a repository of the multitenant computing system to which the tenant is assigned. The tenant is configured consistent with the target set of software components.

In some variations one or more of the following features can optionally be included in any feasible combination. The configuring of the tenant can include assigning the software components present in the bottom layer at the multitenant computing system as being used or not used in the tenant according to the metadata definition of the target set for the layer. The layer can include a first layer of a plurality of layers corresponding to a first solution for the tenant of the plurality of tenants, and a second layer of the plurality of layers corresponds to a second solution for a second tenant of the plurality of tenants. The repository can be configured to provide storage for a plurality of tenants, provide a plurality of layers, and provide a plurality of versions, wherein data for each of the plurality of tenants is separated based on the plurality of layers and the plurality of versions. During runtime one of the plurality of tenants can correspond to one of the plurality of layers and one of the plurality of versions. The metadata definition of the target set for the layer can include a designation of an external software component to be available for use by tenants assigned to the layer.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a computer-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a block diagram illustrating features of an example multi-tenant computing framework;

FIG. 2 shows a diagram illustrating various types of content that can be stored in a repository that is part of a multi-tenant computing framework;

FIG. 3 shows a diagram illustrating a repository which can be used in a multi-tenant computing framework;

FIG. 4 is a diagram illustrating an example of an automated layer strategy approach consistent with implementations of the current subject matter; and

FIG. 5 is a process flow diagram illustrating aspects of a method having one or more features consistent with implementations of the current subject matter.

When practical, similar reference numbers denote similar structures, features, or elements.

### DETAILED DESCRIPTION

As discussed above, a software as a service (SaaS) (also commonly referred to as a cloud software) arrangement can be used to implement a business software framework, system architecture, etc. hosted on computing hardware such as servers and data repositories that are maintained remotely from customer organizations' locations and that are accessed by authorized users at these various organizations via a thin client, such as for example a web browser, over a network. In a software delivery configuration in which services of a business software framework provided to each of multiple organizations are hosted on separate dedicated systems that are accessible only to the individual organization, the software installation at these dedicated systems can be customized and configured for the needs of each customer organization. To make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes. A tenant, as used herein, refers to an isolated unit of data, metadata, and customizable software functionality that is accessible by a single organization and it's associated personnel. The isolated unit is retained in a common repository 114 (see below) with data, metadata, and customizable software functionality provided to other organizations.

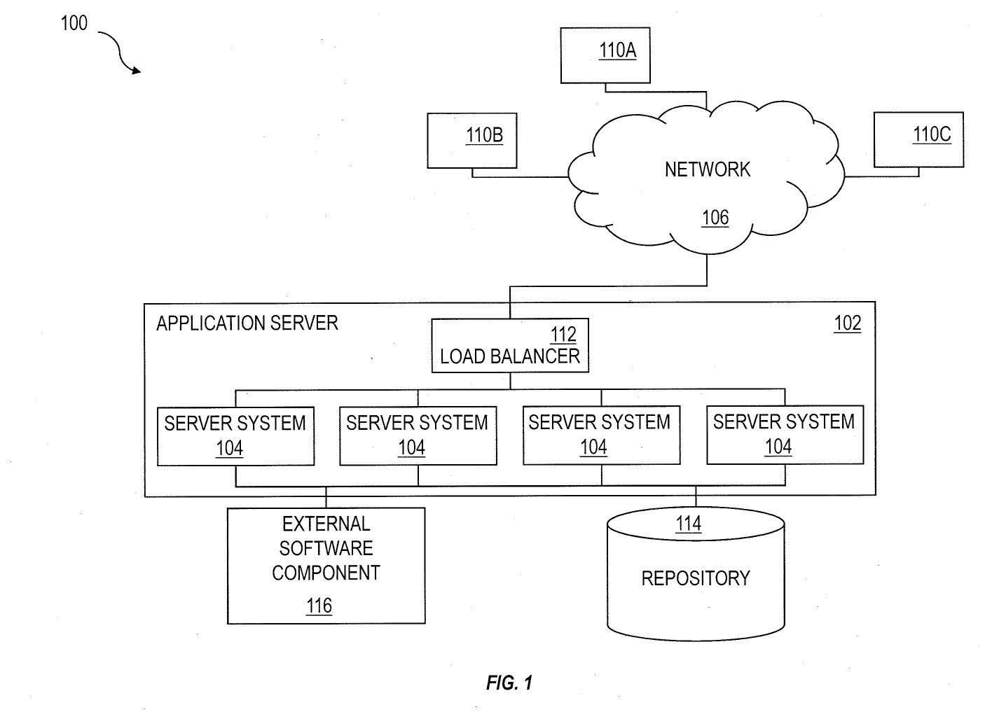

In cloud software environments, such as for example a framework consistent with one or more features shown the examples illustrated in FIG. 1 through FIG. 3 and described in greater detail below, it can be advantageous to optimize usage of server system resources by running different software solutions in different tenants on the same system. Such an approach can be beneficial in that a total cost of ownership of the system can be reduced. A system landscape need not be configured for each software solution (e.g. for each tenant or for each data center where the computing systems on which a SaaS solution operates) separately. In addition, different application layers can advantageously reuse common technical software components such as a UI framework or a metadata repository. Using conventional approaches that lack automatic logic to determine the correct combination of software layers per tenant, a manual task during tenant setup would be required to setup the repository layer strategy for each tenant. Such an approach is likely to result in errors while increasing setup time and the total cost of ownership relating to hosting of SaaS services.

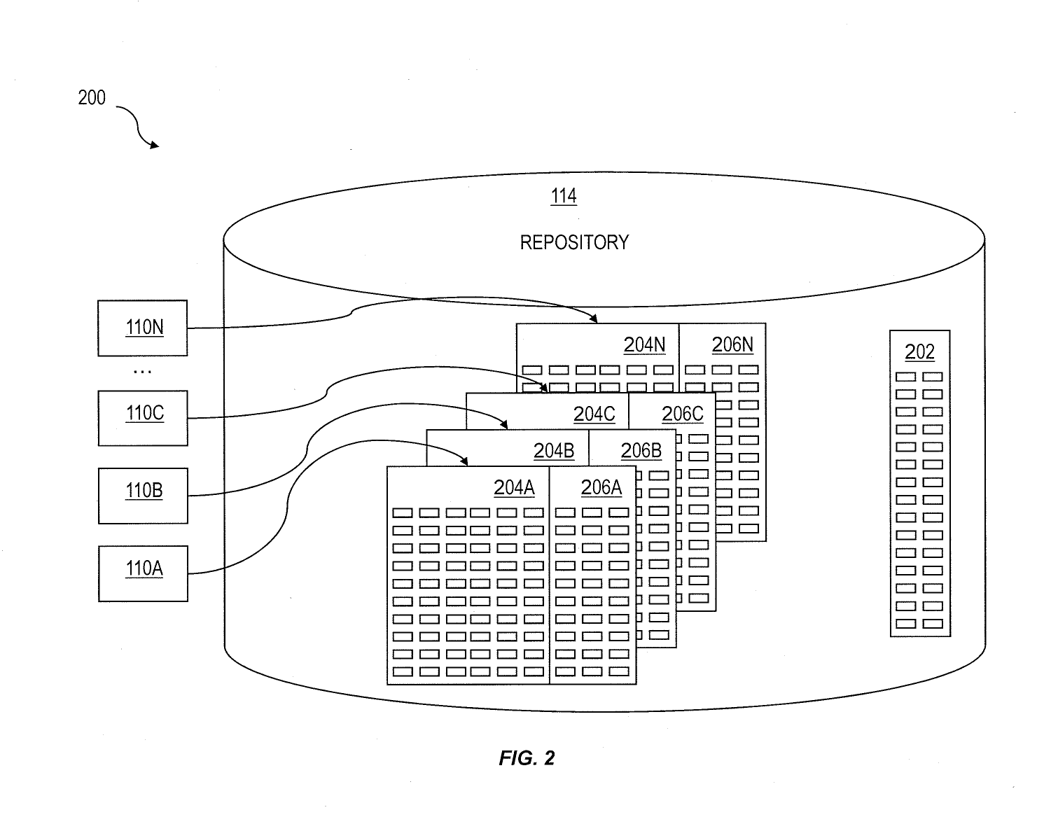

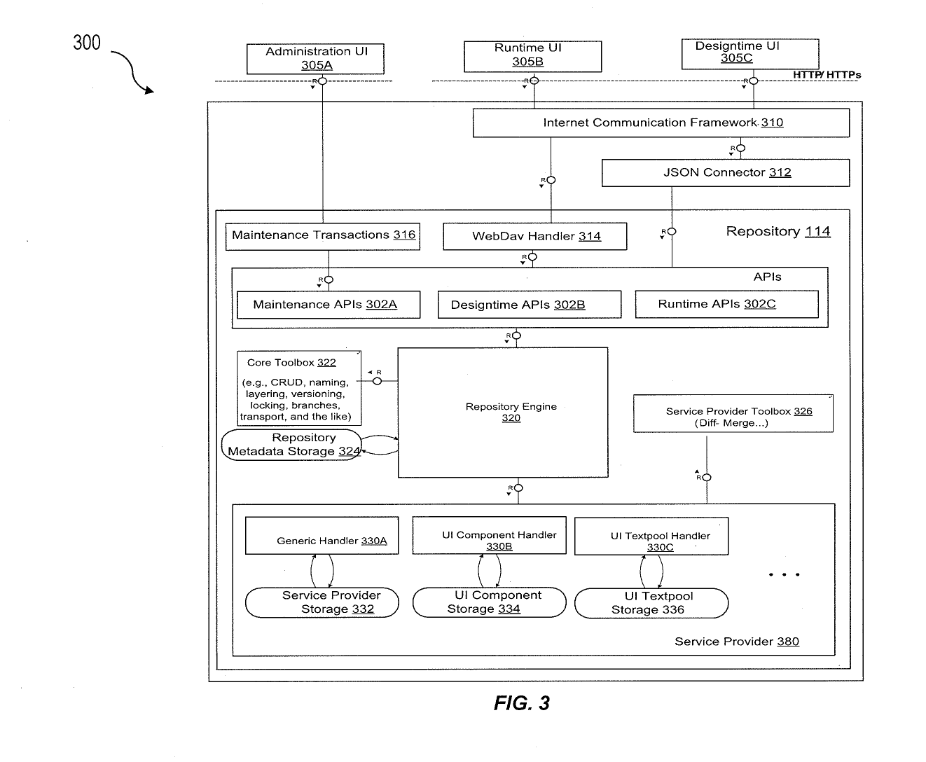

Consistent with implementations of the current subject matter, the installed software components of a SaaS system can be used to determine the required solutions that should be active for a tenant as well as their order in layer strategies. In addition, the logic can allow hosting of systems in which tenants of a multi-tenant system are able to include one or more different add-on solutions (e.g. applications relating to financials, customer relationship management, travel management, etc.). Existing layer strategies can be adapted during system upgrades such that a logic check detects the need for layer strategy changes and automatically performs the required adaptations. FIG. 1, FIG. 2, and FIG. 3 show features of an example software framework in which implementations of the current subject matter can be applied. These examples are in no way meant to be limiting.

FIG. 1 shows a block diagram of a multi-tenant implementation of a software delivery architecture 100 that includes an application server 102, which can in some implementations include multiple server systems 104 that are accessible over a network 106 from client machines operated by users at each of multiple organizations 110A-110C (referred to herein as “tenants” of a multi-tenant system) supported by a single software delivery framework 100.

For a system in which the application server 102 includes multiple server systems 104, the application server can include a load balancer 112 to distribute requests and actions from users at the one or more organizations 110A-110C to the one or more server systems 104. Instances of the core software platform can be executed in a distributed manner across the server systems 104. A user can access the software delivery architecture across the network using a thin client, such as for example a web browser or the like, or other portal software running on a client machine. The application server 102 can access data and data objects stored in one or more data repositories 114. The application server 102 can also serve as a middleware component via which access is provided to one or more external software components 116 that can be provided by third party developers.

To provide for customization of the core software platform 104 for each of multiple organizations supported by a single software delivery framework 100, the data and data objects stored in the repository or repositories 114 that are accessed by the application server 102 can include three types of content as shown in FIG. 2: core software platform content 202, system content 204, and tenant content 206. Core software platform content 202 includes content that represents core functionality and is not modifiable by a tenant. System content 204 can in some examples be created by the runtime of the core software platform and can include core data objects that are modifiable with data provided by each tenant. For example, if the core software platform 104 is an enterprise resource planning (ERP) system that includes inventory tracking functionality, the system content 204A-204N can include data objects for labeling and quantifying inventory. The data retained in these data objects are tenant-specific, for example, each tenant 110A-110C stores information about its own inventory.

The tenant content 206A-206N includes data objects or extensions to other data objects that are customized for one specific tenant 110A-110C to reflect business processes and data that are specific to that specific tenant and are accessible only to authorized users at the corresponding tenant. Such data objects can include a key field to identify a specific organization or tenant within the multi-tenant environment of FIG. 1 as well as one or more of master data, business configuration information, transaction data or the like. For example, tenant content 206 can include user interface components customized for a specific organization or tenant within the multi-tenant environment of FIG. 1 as well as condition records in generated condition tables, access sequences, price calculation results, or any other tenant-specific values. A combination of the software platform content 202 and system content 204 and tenant content 206 of a specific tenant are presented to users from that tenant such that each tenant is provided access to a customized solution having data that is available only to users from that tenant.

For a system in which the application server 102 includes multiple server systems 104, the application server can include a load balancer 112 to distribute requests and actions from users at the one or more organizations 110A-110C to the one or more server systems 104. A user at 110A-N can access the software delivery architecture across the network using a thin client, such as for example a web browser or the like, or other software running on a physical machine. The application server 102 can access data and data objects stored in one or more data repositories 114.

FIG. 3 shows a block diagram 300 illustrating an example implementation of the data repository 114. The data repository 114 can include data (also referred to herein as data content, content, and/or data objects) for the software delivery framework 100 and can be a multi-layered and multi-versioned repository storing tenant content in a clearly separated manner for each of a plurality of tenants. For example, for a given tenant, the given tenant appears as a single layered and single-versioned repository during runtime. The layering and versioning are thus transparent for the end using tenants. The visibility of layers and versions may also be configured for each tenant.

The data repository 114 can include one or more tables. A repository solution can in some examples be a primary key common to all of the tables associated with a given tenant in a multi-tenant system. For example, a given project can include a repository solution (including a primary key) associating a first table with other tables. Thus, data for a given tenant can be layered using the solution (e.g., the primary key of the tables) to identify which entity (or entities) is entitled to access (e.g., view, read, write, and/or modify, etc.) data associated with the tables.

Access to the data repository 114 can be further enhanced by layering solutions. In addition, the order of solutions can provide a mechanism for controlling access to each of the layers. For example, a bottom layer can relate to a first tenant, another layer on the first layer may relate to a second tenant, and so forth. Moreover, the top-most layer in this example can be a user-specific layer for personalization to a given end user. Each of the layers can be configured as read-only or writeable. Layering as described herein enables separation of content from different sources, modification-free changes at the tenants, and tenant specific configurations which determine the visibility of the contents to other entities.

The data repository 114 can include data for each of a plurality of tenants (e.g., at organizations 110A-N) within the multi-tenant environment of FIG. 1. Such data can include tenant content 206, although the data can also include core software platform content 202 and system content 204 as well. The data repository 114 can include a plurality of application programming interfaces (APIs) 302A-C, each of which can be accessed by corresponding user interfaces, such as a maintenance user interface 305A, a runtime user interface 305B, and a designtime user interface 305C. The user interfaces 305A-C can be implemented as a thin client, although other types of clients can be used as well.

The administrative user interface 305A can enable a user (e.g. a developer, a system administrator, and the like) to establish, manage, and/or maintain the data repository 114. For example, the administrative user interface 305A can be used to register a service provider, create repository solutions, create projects, handle transport of data objects, and other administrative/maintenance matters. The designtime user interface 305C enables a user to operate in a designtime mode (e.g., to design user element components, and the like). On the other hand, the runtime user interface 305B enables a user to operate in a runtime mode (e.g., to run the user element components at user interface 305B).

The designtime user interface 305C and the runtime user interface 305B can communicate via an internet communication framework 310 using protocols, such as hypertext transfer protocol (HTTP), hypertext transfer protocol secure (HTTPS), and Simple Mail Transfer Protocol (SMTP). In some implementations, simple HTTP-calls (e.g., get, post, etc.) are routed directly to handler 314 or via a Java Script Object Notation (JSON) connector 312 to the data repository APIs 302A-C. The JSON connector 312 provides a JSON-complaint data-interchange format.

The handler 314 provides an interface used to upload unstructured data to the designtime user interface 305C and the runtime user interface 305B. The handler 314 can provide a web interface supporting, for example, HTTP browsing. The handler 314 can also be used to upload and download content into the data repository 114. The handler 314 can also support Web Distributed Authoring and Versioning (WebDav). When this is the case, the handler 314 includes a WebDav Server configured with WebDav functions, such as options, get, profind, put, delete, copy, move, and the like.

The maintenance transaction 316 can handle maintenance transactions, such as ABAP-based transactions, to administrate the repository 114, such as for example the creation of a new repository solution or the definition of a new layer strategy.

The data repository 114 can include a repository engine 320 for providing a central processing unit including a memory, the core toolbox module 322, metadata storage 324, a service provider toolbox 326, and a service provider 380. In some implementations, the repository engine 320 and the core toolbox module 322 can be configured to provide one or more of the following functions: create, read, update, delete, query, addressing, naming, layering, versioning, locking, transport handling, caching, branches, a registry, and the like. Moreover, the repository engine 320 is responsible for storing, retrieving, and searching for content, such as resource-based content including XML files. The repository engine 320 can also provide multi-version support, layering, and revision control (e.g., check-in, check-out, file-locking, activation, where-used, and version-merge).

The core tool box 322 can provide so-called “branches” to enable management of data objects. A branch can be defined (e.g., configured) at the outset of development or some other type of activity. For example, before being able to add content to data repository 114, repository solution can be defined. The repository solution can include one or more defined attributes further defining a given branch. The branch can be fixed so that the branch is not changed after the initial establishment of the branch. For example, a branch can be defined as a full branch or a delta branch. A software release can be a full branch, while a support package can be a delta branch.

The APIs 302A-C can enable access to core functionalities at the core toolbox module 322. These core functionalities can enable operations to be performed on data content which is managed by the data repository 114.

The data content managed by the data repository 114 can be separated into metadata content, such as solutions, branches, file paths, versions, administrative data, and the like, and the data content itself (e.g., an XML file streamed as a so-called blob). The data repository 114 core can typically store metadata content, while data content can be stored by one or more service providers (e.g. a service provider 380). Content metadata can be managed by the data repository 114 core homogeneously for all content regardless of the type of content. However, depending on the type of content, dedicated service providers 380 can manage data content heterogeneously, and specific, individual actions (such as plausibility checks) can be performed by the service provider 380. Both content metadata and data can be accessed uniformly by a user interface via APIs 302A-C.

The service provider toolbox 326 can provide operations such as a diff-merge (described further below), which can be used by one or more service providers, such as a service provider 380 providing an external software component 116 (see FIG. 1), which can include one or more functions, such as a generic service provider storage 332, a user interface component storage service provider 334, and a user interface text pool storage 336, all of which can be used by the data repository 114 and serve as a set of templates for developing other service providers.

The handlers 330A-C can be implemented as a service provider and can be responsible for the implementation of content type-specific semantics (e.g., plausibility checks and content type-specific additional storage).

The service provider 380 can provide the generic service provider storage 332 to store unstructured data objects, such as dynamic link libraries, images, simple blob storage, and the like. The generic service provider storage 332 can, in some implementations, store the data objects in a database in a database table, which uses a key provided by the data repository 114.

For structured information like user interface components, the service provider 380 can provide user interface component storage service provider 334. The user interface component storage service provider 334 includes metadata representative of the internal buildup of a user interface component (e.g., a model part, a controller part, and a view part). The model part contains a binding to business objects and represents the data sources available in the user interface. The controller part represents user interface logic and includes/references script coding. The view part contains the user elements and layout.

The service provider 380 can include user interface text pool storage 336 for storage of a segment, which lists all the language dependent text strings used in a user interface.

Consistent with implementations of the current subject matter, an existing layer strategy on a multi-tenant system can be adapted automatically when changes to the existing layer strategy logic are required. A new software release, a migration process (e.g. moving tenants from one system to another), a manual command to re-order the layers for improved efficiency or to streamline the system configuration, or the like can necessitate such changes. During a migration, obsolete layers can be removed, new layers can be added, and incorrect ordering of layers can be corrected. Logic for calculating and correcting layer strategies consistent with implementations of the current subject matter can be applied as follows.

As noted above in reference to FIG. 1, FIG. 2, and FIG. 3, a repository 114 can store metadata and can contain a set of objects for providing a variety of functionality. For example, the set of data objects can include one or more of user interface objects, table templates, process models, data models, business object models, business objects, other data objects, master data, transactional data, and relationships between the entities in the repository 114.

Control of the visibility of the various objects in the repository for individual tenant sin a multi-tenant system can be handled at a layer level. For example, each repository object can be assigned to a layer, and a layer strategy defined for a given tenant can determine an order in which the objects are read. In other words, the layer strategy for a tenant specifies which object can be “seen” or are active in that tenant. In some implementations of the current subject matter, a layer strategy for one or more or even all of the tenants in a multitenant system can also include one or more partner solutions (e.g. one or more external software components 116 supported by one or more service providers 380).

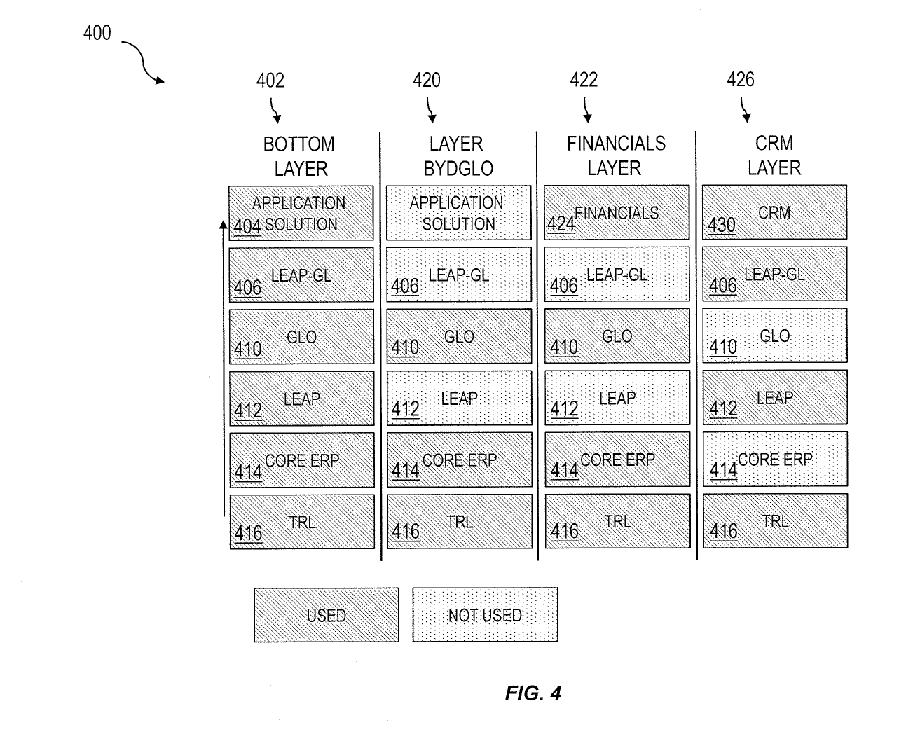

FIG. 4 shows a chart 400 illustrating example of how the current subject matter can be applied to support multiple different active tenant configurations on a single multi-tenant system. An ordered list of repository solutions in the repository 114 can include a list of solutions (e.g. software components) that are valid for a current release, version, etc. of the core software platform 104. This ordered list can be included as a bottom layer installed at a computing system 102 consistent with implementations of the current subject matter. An application solution 404, which can be a hard coded solution can be part of the bottom layer 402, as can other software components supporting functionality that can be supported on the computing system 102. For example, the ordered list in the bottom layer 402 can include one or more add-on solutions, such as for example a large enterprise application platform for globalization (LEAP-GL) solution 406, a globalization (GLO) solution 410, a large enterprise application platform (LEAP) solution 412, a core enterprise resource planning solution 414, a technical reuse layer (TRL) solution 416, or the like.

A computing system 102 can be shipped with a layer configuration installed, or alternatively a new release can be installed on a computing system with the layer configuration installed such that a bottom layer 402 includes the software components or solutions capable of being installed in the layer corresponding to each of a plurality of tenants. The use of the term installed refers here to making a target set of software solutions or components (generically referred to as software components) available to a tenant according to a definition of the target set. The definition of the target set can be set at configuration time for a specific tenant, and can be implemented at a first execution of the tenant (e.g. on first access by a user of the tenant after system set-up, installation of a new release or version, etc.).

Per tenant, the definition of the tenant target set can differ. In this manner, for example, a configuration of a bottom layer 402 of a system can include the software components or solutions capable of being installed in a tenant as part of the release. Referring again to FIG. 4, a first layer 420 can be defined to include a “light” install of base functionality of the core software platform 104 (in this case the core ERP 414) along with the TRL solution 416. The GLO solution 410 can also be included in this layer. This layer can be automatically configured based on a target set definition that applies for this layer, and by extension for one or more tenants on the system that use the configuration of the first layer 420. Other software components in the bottom layer 402 can be designated as not used and therefore hidden for tenants using the first layer 420.

A second layer 422 can include a financials solution 424, which can optionally be an external software component 116 supplied by a service provider 380. The target set definition for this second layer can include the GLO solution 410, the core ERP solution 414, and the TRL solution 416, while the other components in the bottom layer 402 can be designated as not used.

A third layer 426 can include a financials solution 424, which can optionally be an external software component 116 supplied by a service provider 380. The target set definition for this third layer can include the LEAP-GL solution 406, the LEAP solution 412, and the TRL solution 416, while the other components in the bottom layer 402 can be designated as not used.

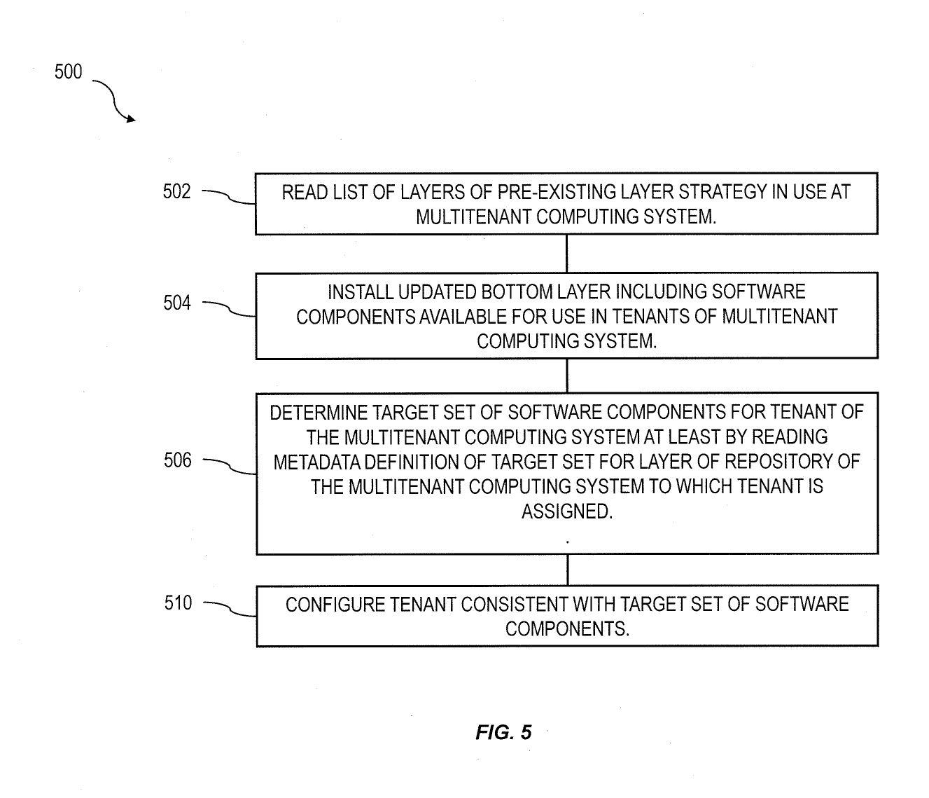

FIG. 5 shows a process flow chart 500 illustrating features of a method consistent with an implementation of the current subject matter. One or more of these features can be included in other implementations.

At 502, a list of layers of a pre-existing layer strategy can be read upon an installation of a new release (e.g. version. etc.) of software at a multitenant computing system 102. At 504, installation of the new release can include installation of an updated bottom layer. The updated bottom layer includes software components available for use in one or more tenants of the multitenant computing system.

In some implementations of the current subject matter, if none of a set of new layers is part of the existing layer strategy, the new bottom layer is not used for that particular layer strategy. Any additional layers of the layer strategy (e.g. partner layers) can checked for existence as repository solutions. If the solution for a layer does not exist anymore, the layer is removed. If the solution exists the layer and its relative position in the layer strategy stays untouched.

However, if one of the new bottom layers is a part of the existing layer strategy, the following approach can be used. For solutions in the new bottom layer ordered list, it can be determined whether the software component for the repository solution exists in the system. If not, the solution does not become part of the layer strategy. Similar, if the repository solution itself does not exist in the system, the solution does not become part of the layer strategy. Any additional layers of the layer strategy (e.g. partner layers) can be checked for existence as repository solutions.

At 506, a target set of software components for a tenant of the multitenant computing system is determined, at least in part by reading a metadata definition of the target set for a layer of a repository of the multitenant computing system to which the tenant is assigned. As discussed above, more than one layer can optionally be defined for the computing system on which the multitenant functionality is hosted. In this manner, a bottom layer for the computing system can be rolled out, and this bottom layer can optionally be standardized for a number of computing systems. Different tenants on the multitenant computing system can be assigned to different layers, each having a different target set of components active for that layer.

At 510, the layer is configured consistent with the target set of software components. The configuring includes assigning the software components present in the bottom layer at the multitenant computing system as being used or not used in the configured layer.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations can also be within the scope of the following claims.

What is claimed is:

1. A computer program product comprising a machine-readable medium storing instructions that, when executed by at least one programmable processor, cause the at least one programmable processor to perform operations comprising:
reading, upon an installation of a new software release at a multitenant computing system, a list of layers of a pre-existing layer strategy in use at the multitenant computing system;
installing, as part of the installation of the new release an updated bottom layer in a repository of the multitenant computing system, the updated bottom layer comprising software components available for use in one or more tenants of the multitenant computing system;
determining a target set of software components for a tenant of the multitenant computing system, the determining comprising reading a metadata definition of the target set for a layer of a repository of the multitenant computing system to which the tenant is assigned; and
configuring the tenant consistent with the target set of software components.

2. A computer program product as in claim 1, wherein the configuring of the tenant comprises assigning the software components present in the bottom layer at the multitenant computing system as being used or not used in the tenant according to the metadata definition of the target set for the layer.

3. A computer program product as in claim 1, wherein the layer comprises a first layer of a plurality of layers corresponding to a first solution for the tenant of the plurality of tenants, and a second layer of the plurality of layers corresponds to a second solution for a second tenant of the plurality of tenants.

4. A computer program product as in claim 1, wherein the repository is configured to provide storage for a plurality of tenants, provide a plurality of layers, and provide a plurality of versions, wherein data for each of the plurality of tenants is separated based on the plurality of layers and the plurality of versions, and wherein during runtime one of the plurality of tenants corresponds to one of the plurality of layers and one of the plurality of versions.

5. A computer program product as in claim 1, wherein the metadata definition of the target set for the layer comprises a designation of an external software component to be available for use by tenants assigned to the layer.

6. A system comprising:
at least one programmable processor; and
a machine-readable medium storing instructions that, when executed by the at least one programmable processor, cause the at least one programmable processor to perform operations comprising:
reading, upon an installation of a new software release at a multitenant computing system, a list of layers of a pre-existing layer strategy in use at the multitenant computing system;
installing, as part of the installation of the new release an updated bottom layer in a repository of the multitenant computing system, the updated bottom layer comprising software components available for use in one or more tenants of the multitenant computing system;
determining a target set of software components for a tenant of the multitenant computing system, the determining comprising reading a metadata definition of the target set for a layer of a repository of the multitenant computing system to which the tenant is assigned; and
configuring the tenant consistent with the target set of software components.

7. A system as in claim 6, wherein the configuring of the tenant comprises assigning the software components present in the bottom layer at the multitenant computing system as being used or not used in the tenant according to the metadata definition of the target set for the layer.

8. A system as in claim 6, wherein the layer comprises a first layer of a plurality of layers corresponding to a first solution for the tenant of the plurality of tenants, and a second layer of the plurality of layers corresponds to a second solution for a second tenant of the plurality of tenants.

9. A system as in claim 6, wherein the repository is configured to provide storage for a plurality of tenants, provide a plurality of layers, and provide a plurality of versions, wherein data for each of the plurality of tenants is separated based on the plurality of layers and the plurality of versions, and wherein during runtime one of the plurality of tenants corresponds to one of the plurality of layers and one of the plurality of versions.

10. A system as in claim 6, wherein the metadata definition of the target set for the layer comprises a designation of an external software component to be available for use by tenants assigned to the layer.

11. A computer-implemented method comprising:
reading, upon an installation of a new software release at a multitenant computing system, a list of layers of a pre-existing layer strategy in use at the multitenant computing system;
installing, as part of the installation of the new release an updated bottom layer in a repository of the multitenant computing system, the updated bottom layer comprising software components available for use in one or more tenants of the multitenant computing system;
determining a target set of software components for a tenant of the multitenant computing system, the determining comprising reading a metadata definition of the target set for a layer of a repository of the multitenant computing system to which the tenant is assigned; and
configuring the tenant consistent with the target set of software components.

12. A computer-implemented method as in claim 11, wherein the configuring of the tenant comprises assigning the software components present in the bottom layer at the multitenant computing system as being used or not used in the tenant according to the metadata definition of the target set for the layer.

13. A computer-implemented method as in claim 11, wherein the layer comprises a first layer of a plurality of layers corresponding to a first solution for the tenant of the plurality of tenants, and a second layer of the plurality of layers corresponds to a second solution for a second tenant of the plurality of tenants.

14. A computer-implemented method as in claim 11, wherein the repository is configured to provide storage for a plurality of tenants, provide a plurality of layers, and provide a plurality of versions, wherein data for each of the plurality of tenants is separated based on the plurality of layers and the plurality of versions, and wherein during runtime one of the plurality of tenants corresponds to one of the plurality of layers and one of the plurality of versions.

15. A computer-implemented method as in claim 11, wherein the metadata definition of the target set for the layer comprises a designation of an external software component to be available for use by tenants assigned to the layer.

16. A computer-implemented method as in claim 11, wherein at least one of the reading, the installing, the determining, and the configuring is performed by at least one programmable processor.
